(19) United States
(12) Patent Application Publication
(10) Pub. No.: US 2009/0122432 A1
(43) Pub. Date: May 14, 2009

(54) MICRO-DEVICE AND METHOD FOR MANUFACTURING THE SAME

(75) Inventors: Naoki KIKUCHI, Saitama (JP); Eiichi ITO, Chiba (JP); Jun MIZUNO, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/269,099

(22) Filed: Nov. 12, 2008

(30) Foreign Application Priority Data
Nov. 12, 2007 (JP) 2007-292864

(51) Int. Cl. G02B 7/182; B44C 1/22

(52) U.S. Cl. 359/872; 216/24

(57) ABSTRACT

A micro-device includes a frame configured to form a cavity surrounded thereby, the frame having a first opening and a second opening opposite to the first opening, a movable portion provided in the cavity, a supporting portion configured to support the movable portion in the cavity, a first sealing member configured to be bonded with the frame and to seal the first opening of the frame, and a second sealing member configured to be bonded with the frame and to seal the second opening of the frame. The frame includes an alignment structure configured to align at least one of the first sealing member and the second sealing member relative to the frame.

### BACKGROUND OF THE INVENTION

The following description relates to one or more micro-devices configured to have a movable portion supported in a cavity surrounded by side walls thereof.

Recently, along with progress in a Micro Electro Mechanical Systems (MEMS) technology, a micro-device such as a micro-mirror device has been developed and put into practical use. The micro-mirror device is implemented into various kinds of devices such as a barcode reader and a laser printer and used as an optical scanner configured to scan an object with scanning light. Japanese Patent Provisional Publication No. 2003-57575 discloses an electrostatically-driven micro-mirror device configured to oscillate a mirror using an electrostatic attractive force generated between the mirror and electrodes.

The micro-mirror device has a microscopic structure, and therefore its performance might be deteriorated by a minute foreign material such as a dust adhered to the mirror or the electrodes. For example, when a foreign material is adhered to a surface of the mirror, light incident onto the surface of the mirror from a light source might be so scattered by the foreign material that the scanning light becomes scattered light. It could result in an undesired situation such as a significant energy loss of the scanning light, a large spot diameter of the scanning light, and a situation where the scanning light is not scanned on intended locations. Further, the foreign material might be adhered to a movable portion and disturb an operation of the mirror. In addition, when the foreign material is adhered to surfaces of the electrodes, the electrostatic attractive force between the mirror and the electrodes varies and causes an undesired situation that the mirror is oscillated by a different oscillation angle from an intended one. Especially, the electrostatically-driven micro-mirror device has a disadvantage that particles in an atmosphere are likely to be collected onto the electrodes by the electrostatic attractive force. Furthermore, the mirror device might be short-circuited between the electrodes via the foreign material staying therebetween. Additionally, when the foreign material is adhered to the mirror, the mirror might thereby become so heavier that a resonant frequency of the mirror becomes lower (namely, a scanning speed becomes lower), or that a movable range of the mirror becomes narrower. Hence, in order to solve the above problems, generally employed is such a configuration to improve dust resistance that the mirror and the electrodes are housed and hermetically sealed inside a cavity.

### SUMMARY OF THE INVENTION

When the cavity that has the mirror housed therein is hermetically sealed, for example, with a sealing member, a frame surrounding the cavity and the sealing member are aligned and joined together. However, since the frame and the sealing member are microscopically structured, a highly accurate alignment is required therebetween. Accordingly, an alignment error that incurs a low yield in manufacturing the micro-mirror device might be caused therebetween.

The present invention is advantageous to provide one or more micro-devices and methods for manufacturing the micro-devices that make it possible to attain easy alignment of a sealing member for sealing a movable portion and a high yield in manufacturing the micro-devices.

According to aspects of the present invention, a micro-device is provided, which includes a frame configured to form a cavity surrounded thereby, the frame having a first opening and a second opening opposite to the first opening, a movable portion provided in the cavity, a supporting portion configured to support the movable portion in the cavity, a first sealing member configured to be bonded with the frame and to seal the first opening of the frame, and a second sealing member configured to be bonded with the frame and to seal the second opening of the frame. The frame includes an alignment structure configured to align at least one of the first sealing member and the second sealing member relative to the frame.

Optionally, the first sealing member may be formed with an outside dimension equal to or smaller than an outside dimension of the cavity, and the second sealing member may be formed with an outside dimension equal to or smaller than the outside dimension of the cavity.

Optionally, the alignment structure may be formed such that the at least one of the first sealing member and the second sealing member is fitted thereinto.

Still optionally, the alignment structure may be formed as a step into which the at least one of the first sealing member and the second sealing member is fitted.

Optionally, the frame, the movable portion, and the supporting portion may be integrally formed.

Yet optionally, the cavity may be hermetically sealed.

According to aspects of the present invention, further provided is a method for manufacturing a micro-device configured with a movable portion supported in a cavity surrounded by one or more side walls. The method includes a first mask patterning step of forming a first mask pattern on a first surface of each die included in a wafer so as to define a first exposed region uncovered with the first mask on the first surface, a first etching step of etching the first exposed region at a predetermined depth so as to form a first step structure configured such that a region outside the first exposed region protrudes from the first exposed region, a second mask patterning step of forming a second mask pattern so as to define a second exposed region uncovered with the second mask in the first exposed region, a second etching step of etching the second exposed region at a predetermined depth so as to form part of the one or more side walls, a third mask patterning step of forming a third mask pattern so as to define a third exposed region uncovered with the third mask in the second exposed region, a third etching step of etching the third exposed region and forming rests of the one or more side walls surrounding the cavity and the movable portion supported in the cavity, a first alignment step of aligning a first sealing member relative to the first step structure such that the first sealing member is fitted into the first step structure, and a first bonding step of bonding the first sealing member with the first step structure.

Optionally, the method may further include a fourth mask patterning step of forming a fourth mask pattern on a second surface opposite to the first surface of each die included in the wafer so as to define a fourth exposed region uncovered with the fourth mask on the second surface, a fourth etching step of etching the fourth exposed region at a predetermined depth so as to form a second step structure configured such that a region outside the fourth exposed region protrudes from the fourth exposed region, a fifth mask patterning step of forming a fifth mask pattern so as to define a fifth exposed region uncovered with the fifth mask in the fourth exposed region, a fifth etching step of etching the fifth exposed region at a predetermined depth so as to form part of the one or more side walls, and a sixth mask patterning step of forming a sixth mask pattern so as to define a sixth exposed region uncovered with the sixth mask in the fifth exposed region. In the third etching step, the sixth exposed region may be etched as well as the third exposed region so as to form rests of the one or more side walls surrounding the cavity and the movable portion supported in the cavity. In this case, the method may further includes a second alignment step of aligning a second sealing member relative to the second step structure such that the second sealing member is fitted into the second step structure, and a first bonding step of bonding the second sealing member with the second step structure.

Optionally, in the first bonding step, the cavity may be hermetically sealed.

### BRIEF DESCRIPTION OF THE ACCOMPANYING DRAWINGS

FIG. 1 is a perspective exploded diagram showing a configuration of a micro-mirror device in an embodiment according to one or more aspects of the present invention.

FIG. 2 is a cross-sectional view showing the configuration of the micro-mirror device in the embodiment according to one or more aspects of the present invention.

FIGS. 3A to 3F are schematic diagrams illustrating a manufacturing process of a micro-mirror chip in the embodiment according to one or more aspects of the present invention.

### DETAILED DESCRIPTION OF THE EMBODIMENTS

Hereinafter, referring to the accompanying drawings, there will be described a configuration and an operation of a micro-mirror device in an embodiment according to aspects of the present invention.

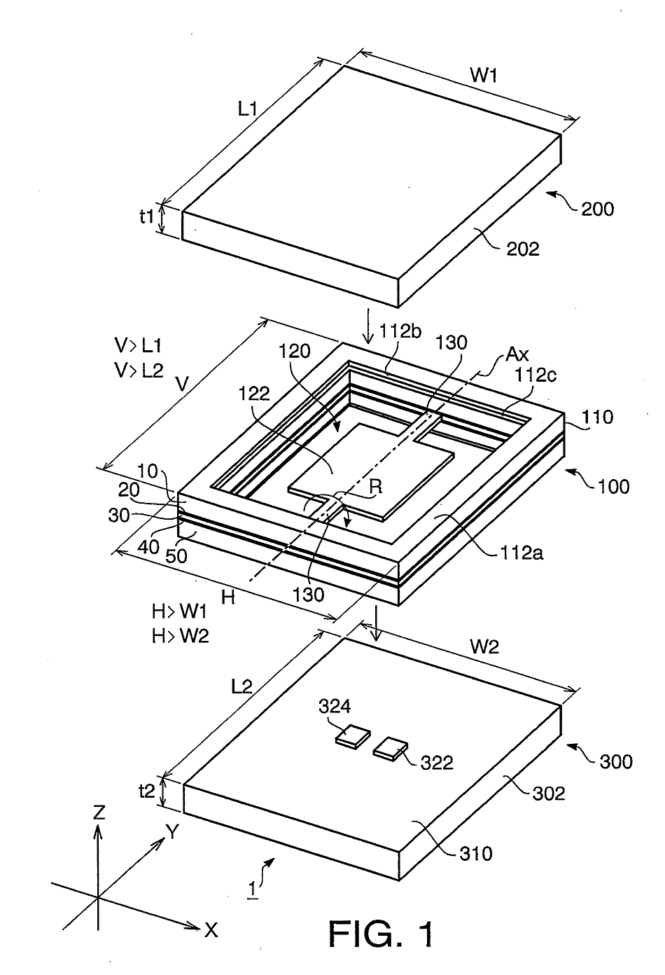

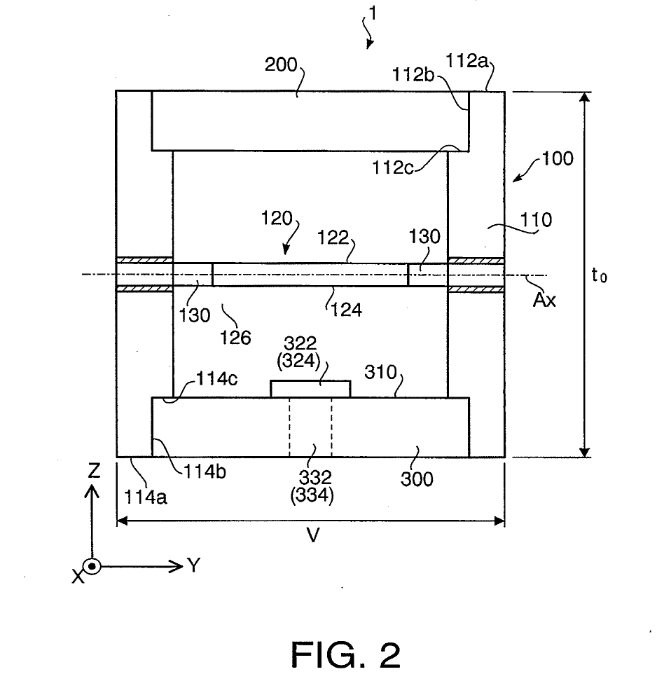

FIG. 1 is a perspective exploded diagram showing a configuration of a micro-mirror device 1 in an embodiment. In addition, FIG. 2 is a cross-sectional view showing the configuration of the micro-mirror device 1. It is noted that mutually orthogonal X, Y, and Z axes are given in FIGS. 1 and 2 for the sake of descriptive convenience. More specifically, FIG. 2 is a cross-sectional view of the micro-mirror device 1 along a Y-Z plane including an axis Ax shown in FIG. 1.

The micro-mirror device 1 is implemented into various devices such as a barcode reader and a laser printer, and supported on a board (not shown) inside each of the various devices. The micro-mirror device 1 is provided with a micro-mirror chip 100, a cap 200, and a substrate 300. As illustrated in FIG. 1, the cap 200 is shaped as a rectangular parallelepiped with a length L1, a width W1, and a thickness t1. In addition, the substrate 300 is a rectangular parallelepiped with a length L2, a width W2, and a thickness t2.

The micro-mirror chip 100 includes a rectangle frame 110 penetrated in a direction along the Z axis. As illustrated in FIG. 1, the rectangle frame 110 has a length H (H>W1 and H>W2) in the X axis direction and a length V (V>L1 and V>L2) in the Y axis direction. In a space surrounded by the frame 110, a movable portion of the micro-mirror chip 100 is formed. The movable portion includes a mirror portion 120 and a pair of torsion bars 130 having the axis Ax as a central axis thereof. One end of each of the bars is joined with the frame 110, and the other end is joined with the mirror portion 120 to support the mirror portion 120 swingably around the axis Ax.

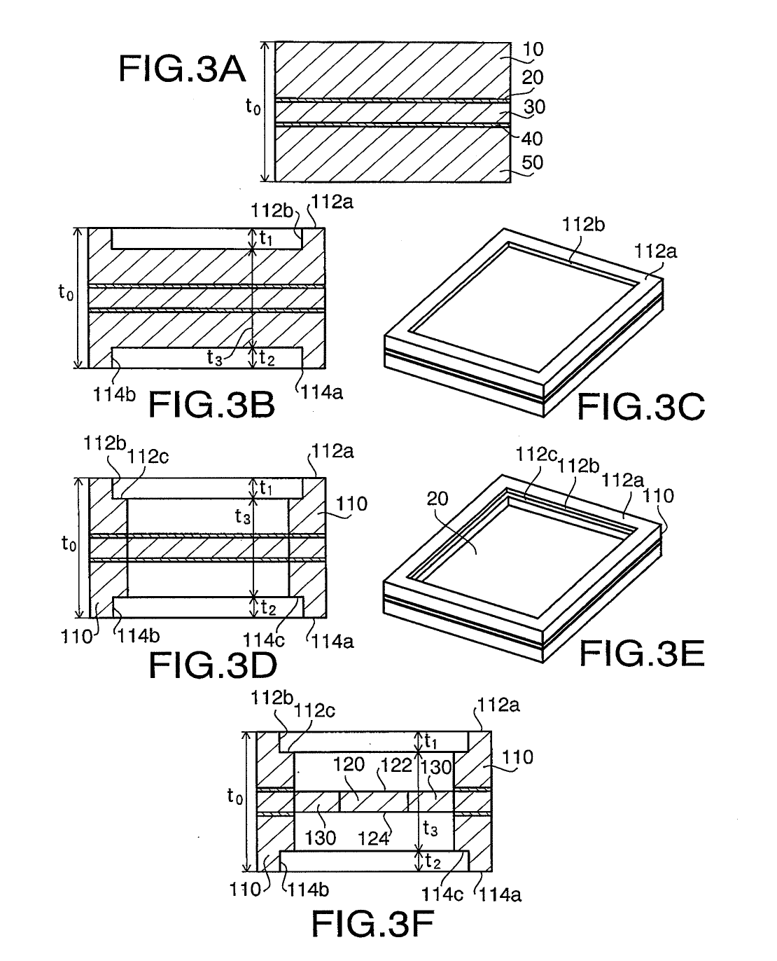

Referring to FIGS. 3A to 3F, a process for manufacturing the micro-mirror chip 100 will be described. The micro-mirror chip 100 is formed from a five-layered wafer in a following manufacturing process.

As shown in FIG. 3A, the wafer has a five-layered structure in which a single-crystal silicon layer 10, an SiO₂ layer 20, a single-crystal silicon layer 30, an SiO₂ layer 40, a single-crystal silicon layer 50 are sequentially accumulated. It is noted that FIGS. 3A to 3F does not show a whole wafer but only a single die included in the wafer for the sake of descriptive convenience. FIGS. 3A, 3B, 3D, and 3F are cross-sectional views of the wafer (die). FIGS. 3C and 3E are perspective views of the wafer (die). The wafer has a thickness t0 in the direction along the Z axis in an unprocessed state, as illustrated in FIG. 3A.

In the manufacturing process shown in FIGS. 3A to 3F, firstly, the wafer shown FIG. 3A is thermally oxidized to form a SiO₂ film thereon. Secondly, a mask pattern is formed on the single-crystal silicon layer 10 through patterning of the SiO₂ film formed. The mask pattern is formed in a region on a top surface 112a of the frame 110 shown in FIGS. 1 and 2. Subsequently, an exposed region of the single-crystal silicon layer 10 uncovered with the mask pattern (hereinafter referred to as a first exposed region) is etched at a predetermined depth t1, for instance, through wet-etching using KOH or Deep Reactive Ion Etching (D-RIE).

When the first exposed region is etched, four upper step surfaces 112b are formed as side surfaces of steps between the etched region and the top surface 112a. Among the four upper step surfaces 112b, two upper step surfaces 112b face each other via the axis Ax at a distance of the width W1 therebetween in a direction along the X axis. Meanwhile, the other two upper step surfaces 112b, which are perpendicular to the axis Ax, face each other at a distance of the length L1 therebetween in a direction along the Y axis.

In addition, the aforementioned successive processes are carried out for a back surface of the wafer, namely, the single-crystal silicon layer 50. Specifically, on the single-crystal silicon layer 50, a mask pattern is formed in a corresponding region on a bottom surface 114a of the frame 110 shown in FIG. 2. In the same-fashion as the first exposed region of the single-crystal silicon layer 10, a region of the single-crystal silicon layer 50 uncovered with the mask pattern (hereinafter referred to as a second exposed region) is etched at a predetermined depth t2.

Further, in the same manner as the upper step surfaces 112b, by etching the second exposed region, four lower step surfaces 114b are formed as side surfaces of steps between the etched region and the bottom surface 114a. Among the four lower step surfaces 114b, two lower step surfaces 114b face each other via the axis Ax at a distance of the width W2 therebetween in the direction along the X axis. Meanwhile, the other two lower step surfaces 114b, which are perpendicular to the axis Ax, face each other at a distance of the length L2 therebetween in the direction along the Y axis.

Through the above successive processes (forming, patterning, and etching of the SiO₂ film) performed for each of the single-crystal silicon layer 10 and the single-crystal silicon layer 50, the wafer is formed into a state shown in FIGS. 3B and 3C, where a part having a thickness t3 in a direction along the Z axis is formed after the first and second exposed regions have been etched at the depths t1 and t2, respectively. The etched depths t1 and t2 are so shallow as not to expose the SiO₂ layers 20 and 40, respectively. The etched depths in the etching processes are adjustable by controlling respective etching times. It is noted that the mask patterns are not shown in FIGS. 3A to 3F for the sake of simplified and easily understandable drawings.

Subsequently, on the single-crystal silicon layer 10, a mask pattern is formed in a corresponding region on an upper bonding surface 112c of the frame 110 as well as the region outside the upper bonding surface 112c. Then, a region of the single-crystal silicon layer 10 uncovered with the mask pattern (hereinafter referred to as a third exposed region) within the first exposed region is etched. Further, on the single-crystal silicon layer 50, a mask pattern is formed in a corresponding region on a lower bonding surface 114c of the frame 110 as well as the region outside the lower bonding surface 114c. Thereafter, a region of the single-crystal silicon layer 50 uncovered with the mask pattern (hereinafter referred to as a fourth exposed region) within the second exposed region is etched.

Here, the SiO₂ layers 20 and 40 serve as etch stop layers, respectively. Namely, as illustrated in FIGS. 3D and 3E, when the third exposed region of the single-crystal silicon layer 1 is completely etched, the etching is stopped at an upper surface of the SiO₂ layer 20 (i.e., a boundary surface between the SiO₂ layer 20 and the single-crystal silicon layer 10). In the same manner, after the fourth exposed region of the single-crystal silicon layer 50 is completely etched, the etching is stopped at a lower surface of the SiO₂ layer 40 (i.e., a boundary surface between the SiO₂ layer 40 and the single-crystal silicon layer 50).

Further, a mask pattern is formed in a region on the SiO₂ layer 20 that corresponds to the mirror portion 120 and the pair of torsion bars 130 (hereinafter referred to as a first movable portion region) in the third exposed region as well as the region outside the third exposed region. In the same manner, a mask pattern is formed in a region on the SiO₂ layer 40 that corresponds to the mirror portion 120 and the pair of torsion bars 130 (hereinafter referred to as a second movable portion region) in the fourth exposed region as well as the region outside the fourth exposed region.

Then, a region of the SiO₂ layer 20 uncovered with the mask pattern (hereinafter referred to as a fifth exposed region) is etched, for example, through reactive ion etching (RIB). In the same way, a region of the SiO₂ layer 40 uncovered with the mask pattern (hereinafter referred to as a sixth exposed region) within the fourth exposed region is etched, for example, through the RIE. Thereafter, the fifth and sixth exposed regions of the single-crystal silicon layer 30 are etched, for example, in a wet manner using KOH.

Subsequently, the first and second movable portion regions of the SiO₂ layers 20 and 40 and the mask patterns thereon are removed, respectively, to form the movable portion. Thereafter, metal films are formed on upper and lower surface regions of the single-crystal silicon layer 30 that correspond to the mirror portion 120, respectively. It is noted that the metal films are not shown in each of the drawings for the sake of simplified and easily understandable drawings. Hereinafter, an upper surface metalized of the mirror portion on a side of the SiO₂ layer 20 will be referred to as an upper mirror surface 122. Meanwhile, a lower surface metalized of the mirror portion on a side of the SiO₂ layer 40 will be referred to as a lower mirror surface 124. When a residual mask pattern is cleaned up and the successive processes shown in FIGS. 3A to 3F are completed, each die taken from the wafer is formed into a state as shown in FIGS. 1 and 3F. More specifically, each die is formed with the frame 110 and the mirror portion 120 suspended via the pair of torsion bars 130 in the space surrounded by the frame 110.

In the present embodiment, since the SiO₂ layers 20 and 40 are employed as the etch stop layers in the etching of the single-crystal layers 10 and 50, respectively, a thickness between the upper mirror surface 122 and the lower mirror surface 124 is accurately defined with the thickness of the single-crystal silicon layer 30 and thicknesses of the metal films on the both surfaces of the single-crystal silicon layer 30. Further, since a distance (thickness) between the upper mirror surface 122 and the lower mirror surface 124 is defined mainly by the thickness of the single-crystal silicon layer 30 sandwiched between the SiO₂ layers 20 and 40 as the etch stop layers, an extremely even thickness can be provided between the upper mirror surface 122 and the lower mirror surface 124. Therefore, even though the layer between the upper mirror surface 122 and the lower mirror surface 124 is thinly formed, it could provide a relatively stable yield in manufacturing the die.

Next, referring back to FIGS. 1 and 2, an operation of the movable portion will be described along with a further explanation of the configuration of the micro-mirror device 1.

As illustrated in FIG. 2, the cap 200 is joined onto an upper face side of the frame 110. Specifically, the cap 200 is fitted into an upper step of the frame 110 with a side thereof with the length L1 parallel to the axis Ax and a side thereof with the width W1 perpendicular to the axis Ax. Since the four upper step surfaces 112b are located as mentioned above with respect to the axis Ax, the cap 200 is fitted into the upper step with no space between side faces 202 of the cap 200 and the upper step surfaces 112b. Additionally, when the cap 200 is compressed in a state where the side faces 202 are closely spaced from the upper step surfaces 112b, a bottom face of the cap 200 comes into close contact with the upper bonding surface 112c of the frame 110. Then, the cap 200 is joined with the frame 110 with the side faces 202 of the cap 200 closely contacting the upper step surfaces 112b of the frame 110 and the bottom face of the cap 200 closely contacting the upper bonding surface 112c, for example, by anodic bonding.

Further, the substrate 300 is joined onto a lower face side of the frame 110. A method for bonding the frame 110 and the substrate 300 is the same as that for bonding the frame 110 and the cap 200. Specifically, the substrate 300 is fitted into a lower step of the frame 110 with a side thereof with the length L2 parallel to the axis Ax and a side thereof with the width W2 perpendicular to the axis Ax. Since the four lower step surfaces 114b are located as mentioned above with respect to the axis Ax, the substrate 300 is fitted into the lower step with no space between side faces 302 of the substrate 300 and the lower step surfaces 114b. Additionally, when the substrate 300 is compressed in a state where the side faces 302 are closely spaced from the lower step surfaces 114b, an upper face of the substrate 300 comes into close contact with the lower bonding surface 114c of the frame 110. Then, the substrate 300 is bonded with the frame 110 with the side faces 302 of the substrate 300 closely contacting the lower step surfaces 114b of the frame 110 and the upper face of the substrate 300 closely contacting the lower bonding surface 114c, for example, by anodic bonding.

Thus, as mentioned above, the micro-mirror device 1 of the present embodiment is configured such that the cap 200 and the substrate 300 can be fitted into the upper and lower steps of the frame 110, respectively. Hence, a precise alignment between a frame (in the present embodiment, the frame 110) and a sealing member (in the present embodiment, the cap 200 and the substrate 300), which has generally been required so far, is not required any more in the present embodiment. Thereby, it is possible to avoid an alignment error and improve the manufacturing yield of the micro-mirror device 1.

Subsequently, the micro-mirror device 1 after the aforementioned bonding process will be described. The frame 110 is, as shown in the manufacturing process of FIGS. 3A to 3F, a part hardly etched on the wafer in a vertical direction (the direction along the Z axis). The thickness t3 between the upper bonding surface 112c and the lower bonding surface 114c is thicker than any of the mirror portion 120 and the torsion bars 130. In addition, the frame 110 is formed to be rectangular so as to surround the mirror portion 120 and the torsion bars 130 by four inner side faces thereof. Therefore, when the cap 120 and the substrate 300 are bonded with the upper and lower bonding surfaces 112c and 114c, respectively, in the aforementioned bonding process, the mirror portion 120 and the torsion bars 130 (and below-mentioned electrodes 322 and 324) are hermetically sealed in a cavity defined by the frame 110, the cap 200, and the substrate 300, as illustrated in FIG. 2.

Additionally, the thickness t3 is determined such that a movable range of the mirror portion 120 is completely housed inside the cavity. Thus, according to the present embodiment, it is possible to define the cavity without having to place a separate element such as a spacer between the micro-mirror chip 100 and the cap 200 and between the micro-mirror chip 100 and the substrate 300. It provides an advantage to omit processes for alignment and bonding between such a separate element with the micro-mirror chip 100.

It is noted that an inside of the cavity may be evacuated. When the inside of the cavity is evacuated, it can provide a stabilizing effect on performance of the micro-mirror device 1. Specifically, for instance, it is possible to neglect a viscosity resistance of air with which the mirror portion 120 would meet, and to stabilize a Q factor of the mirror portion 120.

The cap 200 is formed from optically transparent material, and serves as a window through which laser light is incident onto the mirror portion 120 and reflected out by the mirror portion 120. The laser light, with which a scanned object is scanned, is emitted by a light source (not shown). The laser light transmitted through the cap 200 is incident onto the upper mirror surface 122 and reflected in a direction depending on a tilt angle of the upper mirror surface 122. The reflected light is again transmitted through the cap 200, and scans the scanned object as scanning light emitted by the micro-mirror device 1.

It is noted that a following configuration has been known that does not need any separate element such as a spacer to define the cavity. In the known configuration, instead of a spacer, a wall is formed around a packaging member that serves as a transparent window like the cap 200. However, in such a configuration, for example, when the packaging member is a molded product, the packaging member might have an even thickness due to a surface sink or a camber generated thereon, and cause an undesired optical property thereof. On the contrary, in the present embodiment, as mentioned above, since the micro-mirror device 1 is configured with the cap of the even thickness, such an undesired problem is not caused.

On an upper face 310 of the substrate 300, electrodes 322 and 324 are disposed to face each other via a Y-Z plane including the axis Ax. The electrodes 322 and 324 are electrically connected with wires (not shown) provided from a back surface side of the substrate 300 via through-holes 332 and 334 (see FIG. 2) provided to the substrate 300, respectively. Further, a wire is provided from the mirror portion 120 (the single-crystal silicon layer 30) of the micro-mirror chip 100. The wires are connected with a drive control circuit (not shown). It is noted that the single-crystal silicon layer 30, which is sandwiched between the SiO₂ layers 20 and 40, is electrically isolated from other layers.

When different electric potential differences are applied between the mirror portion 120 and the electrode 322 and between the mirror portion 120 and the electrode 324, respectively, the mirror portion 120 is tilted around the axis Ax. For example, when the drive control circuit is controlled to apply no electric potential difference between the mirror portion 120 and the electrode 324 (both the mirror portion 120 and the electrode 324 are set in a ground level) and to apply an electric potential difference V between the mirror portion 120 and the electrode 322, the mirror portion 120 meets with a moment of force around the axis Ax owing to an electrostatic attractive force generated between the lower mirror surface 124 and the electrode 322. Then, the mirror portion 120 is rotated around the axis Ax in a direction indicated by an arrow R. Meanwhile, when the drive control circuit is controlled to apply no electric potential difference between the mirror portion 120 and the electrode 322 (both the mirror portion 120 and the electrode 322 are set in the ground level) and to apply the electric potential difference V between the mirror portion 120 and the electrode 324, the mirror portion 120 is rotated around the axis Ax in the same manner as described above in an opposite direction of an arrow R.

Hereinabove, the embodiment according to aspects of the present invention have been described. The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without reapportioning to the details specifically set forth. In other instances, well known processing structures have not been described in detail, in order not to unnecessarily obscure the present invention.

Only an exemplary embodiment of the present invention and but a few examples of its versatility are shown and described in the present disclosure. It is to be understood that the present invention is capable of use in various other combinations and environments and is capable of changes or modifications within the scope of the inventive concept as expressed herein.

For example, although L1, L2, W1, and W2 are different reference characters, at least two of the reference characters may represent the same length. For instance, when L1 and W1 represent the same length, the cap 200 can be fitted into the upper step of the frame 110 without having to care about an orientation of the cap 200 relative to the frame 110. Hence, the boding process can be simplified.

In the aforementioned embodiment, the step between the top surface 112a and the upper bonding surface 112c and the step between the bottom surface 114a and the lower bonding surface 114c are formed throughout an entire inner circumference of the frame 110. However; such a step may be partially provided to the frame 110. In this case, the cap 200 is joined with the frame 110 by the anodic bonding in a state where side faces 202 of the cap 200 closely contacts upper step surfaces 112b of the frame 110 (and/or side faces 302 of the substrate 300 closely contacts lower step surfaces 114b of the frame 110). In this case as well, an accurate alignment between the frame 110 and the cap 200 (and/or between the frame 110 and the substrate 300) is not required, and it provides an improving effect on the manufacturing yield of the micro-mirror device 1.

Further, in the aforementioned embodiment, the mirror portion 120 (the upper mirror surface 122) is rectangular. However, the mirror portion 120 (the upper mirror surface 122) may be formed in any other shape such as a circular shape and an oval shape, as far as the mirror surface 122 has a high surface accuracy of an effective region thereon employed as an optical mirror.

In the aforementioned embodiment, the micro-mirror device 1 is configured as a uniaxial one. However, the micro-mirror device 1 may be configured to be tilted around two or more axes.

Further, the wafer may be configured as a single layer of single-crystal silicon without any SiO₂ layer or as a SiO₂ layer sandwiched between two single-crystal silicon layers (hereinafter referred to as an SOI wafer). By accurately controlling an etching time for etching a single-crystal layer, it is possible to accurately determine the thickness of the mirror portion 120, and also to improve the surface accuracies of the upper mirror surface 122 and the lower mirror surface 124. Thus, even though the wafer is configured as a single layer of single-crystal silicon or an SOI wafer, it is possible to manufacture an equivalent of the micro-mirror device 1 in the aforementioned embodiment.

The present disclosure relates to the subject matter contained in Japanese Patent Application No. P2007-292864 filed on Nov. 12, 2007, which is expressly incorporated herein by reference in its entirety.

What is claimed is:

1. A micro-device, comprising:
a frame configured to form a cavity surrounded thereby, the frame having a first opening and a second opening opposite to the first opening;
a movable portion provided in the cavity;
a supporting portion configured to support the movable portion in the cavity;
a first sealing member configured to be bonded with the frame and to seal the first opening of the frame; and
a second sealing member configured to be bonded with the frame and to seal the second opening of the frame,
wherein the frame includes an alignment structure configured to align at least one of the first sealing member and the second sealing member relative to the frame.

2. The micro-device according to claim 1,
wherein the alignment structure is formed such that the at least one of the first sealing member and the second sealing member is fitted thereinto.

3. The micro-device according to claim 2,
wherein the alignment structure is formed as a step into which the at least one of the first sealing member and the second sealing member is fitted.

4. The micro-device according to claim 1,
wherein the frame, the movable portion, and the supporting portion are integrally formed.

5. The micro-device according to claim 1,
wherein the cavity is hermetically sealed.

6. A method for manufacturing a micro-device configured with a movable portion supported in a cavity surrounded by one or more side walls, the method comprising:
a first mask patterning step of forming a first mask pattern on a first surface of each die included in a wafer so as to define a first exposed region uncovered with the first mask on the first surface;
a first etching step of etching the first exposed region at a predetermined depth so as to form a first step structure configured such that a region outside the first exposed region protrudes from the first exposed region;
a second mask patterning step of forming a second mask pattern so as to define a second exposed region uncovered with the second mask in the first exposed region;
a second etching step of etching the second exposed region at a predetermined depth so as to form part of the one or more side walls;
a third mask patterning step of forming a third mask pattern so as to define a third exposed region uncovered with the third mask in the second exposed region;
a third etching step of etching the third exposed region and forming rests of the one or more side walls surrounding the cavity and the movable portion supported in the cavity;
a first alignment step of aligning a first sealing member relative to the first step structure such that the first sealing member is fitted into the first step structure; and
a first bonding step of bonding the first sealing member with the first step structure.

7. The method according to claim 6, further comprising:
a fourth mask patterning step of forming a fourth mask pattern on a second surface opposite to the first surface of each die included in the wafer so as to define a fourth exposed region uncovered with the fourth mask on the second surface;
a fourth etching step of etching the fourth exposed region at a predetermined depth so as to form a second step structure configured such that a region outside the fourth exposed region protrudes from the fourth exposed region;
a fifth mask patterning step of forming a fifth mask pattern so as to define a fifth exposed region uncovered with the fifth mask in the fourth exposed region;
a fifth etching step of etching the fifth exposed region at a predetermined depth so as to form part of the one or more side walls; and
a sixth mask patterning step of forming a sixth mask pattern so as to define a sixth exposed region uncovered with the sixth mask in the fifth exposed region,
wherein, in the third etching step, the sixth exposed region is etched as well as the third exposed region so as to form rests of the one or more side walls surrounding the cavity and the movable portion supported in the cavity,
wherein the method further comprises:
a second alignment step of aligning a second sealing member relative to the second step structure such that the second sealing member is fitted into the second step structure; and
a first bonding step of bonding the second sealing member with the second step structure.

8. The method according to claim 6,
wherein, in the first bonding step, the cavity is hermetically sealed.

9. The micro-device according to claim 1,
wherein the first sealing member is formed with an outside dimension equal to or smaller than an outside dimension of the cavity, and
wherein the second sealing member is formed with an outside dimension equal to or smaller than the outside dimension of the cavity.
